(19) United States
(12) Patent Application Publication
(10) Pub. No.: US 2026/0302998 A1
(43) Pub. Date: Oct. 1, 2026

(54) SUPERVISORY CONTROLLERS FOR MONITORING FAULT EVENTS

(71) Applicant: Rivian IP Holdings, LLC, Irvine, CA (US)

(72) Inventors: Yo Chan SON, Rancho Palos Verdes, CA (US); David TANG, Rancho Cucamonga, CA (US); Fareed Ul Hasan SYED MOHAMMED, Hawthorne, CA (US); Norman CHUA, Irvine, CA (US); Karthik KANDASAMY, Irvine, CA (US); Nisha MISHRA, Carson, CA (US); Armin TEYMOURI, San Pedro, CA (US)

(21) Appl. No.: 19/093,053

(22) Filed: Mar. 27, 2025

(51) Int. Cl. H02P 29/024; B60L 3/00; B60L 15/00; H02M 7/537

(52) U.S. Cl. CPC H02P 29/024; B60L 3/003; B60L 3/0061; B60L 15/007; H02M 7/537; B60L 2240/421

(57) ABSTRACT

A vehicle includes a control circuit (e.g., main control circuit) configured to control power supply to an inverter for an electric motor, as well as a separate control circuit (e.g., supervisory control circuit) that monitors and communicates with the main control circuit. If the main control circuit undergoes a fault, the supervisory control circuit may control the power supply to the inverter in accordance with a safe state operation of the vehicle. The supervisory circuit may also monitor and communicate with an additional circuit (e.g., power management circuit) and control functions of the main circuit in the event of a fault to the additional circuit.

### INTRODUCTION

This application is directed to vehicle controllers, and more particularly, to using a vehicle controller to take over or assume control operations from another vehicle controller when a fault is detected in order to manage a vehicle in a safe state for the duration of the fault. A vehicle may include a controller designated as a main controller, as well as another controller designated as a supervisory controller designed to communicate with the main controller and monitor for faults (e.g., to the main controller) and control safe state operations of the vehicle in the event of a detected fault.

### SUMMARY

In one or more aspects of the present disclosure, an apparatus is described. The apparatus may include a first circuit configured to control one or more functions of an inverter for an electric motor that is configured to operate based on a first voltage. The apparatus may further include a second circuit configured to distribute power, based on a second voltage less than the first voltage, to the first circuit. The apparatus may further include a third circuit. The third circuit may be configured to determine, based on communication with at least one of the first circuit or the second circuit, a state of the first circuit. The third circuit may be further configured to in response to the state indicating a fault to the first circuit, determine a fault action to manage the electric motor. The fault action may include providing a command to control the inverter. The state may include a loss of the second voltage to the first circuit.

The one or more functions may include managing a pulse width modulation (PWM) buffer circuit to a power module. Further, in response to the state indicating the fault, the third circuit is configured to disable the PWM buffer circuit.

Third circuit may be further configured to monitor, based on a current sensor, phase current to the electric motor. Third circuit may be further configured to prior to determining the fault action, determine, based on the phase current to the electric motor, a speed of a vehicle based on the electric motor. The third circuit may be further configured to determine, based on the speed, the fault action.

The one or more functions may further include managing a pulse width modulation (PWM) buffer circuit to a power module. Further, in response to the state indicating the fault, the first circuit is configured to pass control of the PWM buffer circuit to the third circuit. The first circuit may be configured to provide duty cycles of the PWM buffer circuit to a gate driver. The fault action is selected from one of a short circuit high, a short circuit low, or an open.

In one or more aspects of the present disclosure, a method is described. The method may include monitoring, by a supervisory circuit: a first circuit configured to provide a first function including providing a first voltage to an inverter for an electric motor, and a second circuit configured to provide a second function including distributing a second voltage to the first circuit, the second voltage less than the first voltage. The method may further include obtaining, by the supervisory circuit, a state of one of the first circuit or the second circuit. The method may further include in response to determining, based on the state, a fault to the first circuit or the second circuit: determining, by the supervisory circuit and based on the fault, a fault action, and controlling, by the supervisory circuit, the first function in accordance with the fault action. The monitoring, by the supervisory circuit, of the first circuit may include communicating with the second circuit. The fault action may include providing a command to control the inverter. The fault may include a loss of the second voltage to the first circuit.

The first function may include managing a pulse width modulation (PWM) buffer circuit to a power module. The method may further include in response to the state indicating the fault, disabling, by the supervisory circuit, the PWM buffer circuit.

The supervisory circuit may be further configured to: monitor, based on a current sensor, phase current to the electric motor. The supervisory circuity may be further configured to prior to determining the fault action, determine, based on the phase current to the electric motor, a speed of a vehicle based on the electric motor. The method may further include determining, by the supervisory circuit and based on the speed, the fault action.

In one or more aspects of the present disclosure, a vehicle is described. The vehicle may include an electric motor. The vehicle may further include an energy storage system configured to provide a first voltage. The vehicle may further include a battery separate from the energy storage system and configured to provide a second voltage less than the first voltage. The vehicle may further include an inverter including one or more switches configured to operate the electric motor. The vehicle may further include an electronic control unit configured to provide one or more control signals to the inverter. The electronic control unit may include a first circuit configured to control one or more functions of an inverter for an electric motor configured to operate based on the first voltage. The electronic control unit may further include a second circuit configured to distribute power, based on the second voltage, to the first circuit. The electronic control unit may further include a third circuit configured to: determine, based on communication with at least one of the first circuit or the second circuit, a state of the first circuit, and in response to the state indicating a fault to the first circuit, determine a fault action to manage the electric motor. The fault action may include providing a command to control the inverter. The state may include a loss of the second voltage to the first circuit.

The one or more functions includes managing a pulse width modulation (PWM) buffer circuit to a power module. Further, in response to the state indicating the fault, the third circuit may be configured to disable the PWM buffer circuit.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with aspects of the present disclosure.

FIG. 2 illustrates a side view of an alternate example of a vehicle, in accordance with aspects of the present disclosure.

FIG. 3 illustrates a block diagram of a system used to manage aspects of a vehicle, in accordance with aspects of the present disclosure.

FIG. 4 illustrates a block diagram of a vehicle, in accordance with aspects of the present disclosure.

FIG. 5 illustrates a flow diagram showing an example of a process that may be performed for managing one or more operations of a vehicle, in accordance with implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to integrating and utilizing a supervisory circuit (e.g., supervisory control circuit, supervisory microcontroller) to manage or control a safe state of a vehicle when a fault or error arises in the main control circuit (e.g., main microcontroller) and/or to the power management integrated circuit (PMIC). In one or more implementations, the main control circuit described herein is designed to control a traction inverter application for an electric motor(s) in a vehicle. Traditionally, when a fault occurs in the inverter circuitry, a short circuit may be initiated to disable the power module(s) that manage the inverters, thus limiting availability for drive performance. However, when the supervisory circuit is introduced in the vehicle, the supervisory control circuit may, in the event of a fault, control at least some functions previously controlled the main control circuit, such as managing the inverter to control the electric motor(s). In one or more implementations, the main control circuit passes the control capabilities to the supervisory circuit when a fault is detected. The supervisory circuit may subsequently place the vehicle in a safe state operation. In this regard, the supervisory circuit may allow vehicles to maintain certain safety standards in the event of a fault to the main control circuit, thus increasing the likelihood of safety to the passengers in the vehicle.

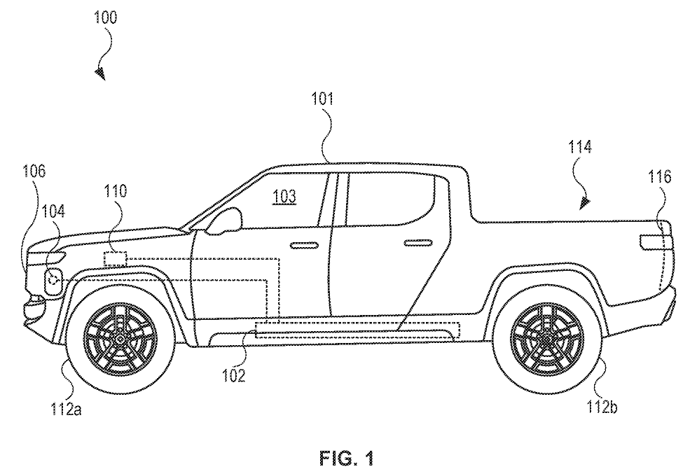

FIG. 1 illustrates a side view of an example of a vehicle 100, in accordance with one or more aspects of the present disclosure. In the example shown in FIG. 1, the vehicle 100 takes the form of a truck. Generally, the vehicle 100 may take the form of any motorized vehicle, including motorized vehicles with an internal combustion engine and/or one or more electric motors. Accordingly, other implementations of the vehicle 100 may include land-based vehicles, such as a car (e.g., sedan, hatchback), a van, or a commercial truck, as non-limiting examples.

The vehicle 100 may include a battery pack 102. The battery pack 102 may be carried by a vehicle body 101 of the vehicle 100, with the vehicle body 101 defining a cabin 103 that provides a space for passengers. The battery pack 102 may be coupled (e.g., electrically coupled) to one or more electrical systems of the vehicle 100 to provide power to the one or more electrical systems. For example, the vehicle 100 may include a port 104 (e.g., charge port) designed to receive a cable connector (not shown in FIG. 1) used to transmit power (e.g., alternating current (AC) power) that is converted to direct current (DC) power to charge the battery pack 102. The vehicle 100 may further include a front end 106 at which one or more lamps (shown below) are generally positioned.

As another exemplary electrical system, the vehicle 100 may include a drive unit 110, representative of one or more additional drive units of the vehicle 100. The battery pack 102 may couple to the drive unit 110. While the drive unit 110 is shown as generally being in the front of the vehicle 100, the drive unit 110 may be located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) wheels of the vehicle 100.

The vehicle 100 may further include a bed 114 that may be used as a storage area for the vehicle 100. In order to access the bed 114, the vehicle 100 may further include a gate 116. Based on its position on the vehicle 100, the gate 116 may take the form of a closure, such as a rear gate or a tailgate. The gate 116 is designed to open, via rotation, thereby allowing further access to the bed 114.

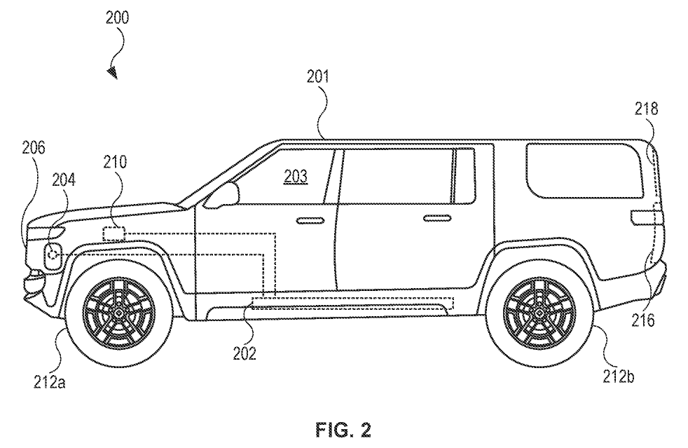

FIG. 2 illustrates a side view of an alternate example of a vehicle 200, in accordance with one or more aspects of the present disclosure. As shown, the vehicle 200 takes the form of a sport utility vehicle (SUV). The vehicle 200 may include several features shown and/or described for the vehicle 100 (shown in FIG. 1). For example, the vehicle 200 may include a vehicle body 201, a battery pack 202, a cabin 203, a port 204 (e.g., charge port), a front end 206, a drive unit 210 (representative of one or more additional drive units), a wheel 212a (representative of an additional front wheel), and a wheel 212b (representative of an additional rear wheel).

The cabin 203 of the vehicle 200 may extend to a rear portion of the vehicle 200. In order to access the rear portion of the cabin 203, the vehicle 200 may further include a gate 216. Based on its position on the vehicle 200, the gate 216 may take the form of a rear gate or a liftgate. The gate 216 is designed to open, via rotation, thereby allowing access to the cabin 203. Additionally, the vehicle 200 may include an enclosure 218. In one or more implementations, the enclosure 218 takes the form of a glass panel. Similar to the gate 216, the enclosure 218 is designed to open, via rotation, thereby allowing further access to the cabin 203.

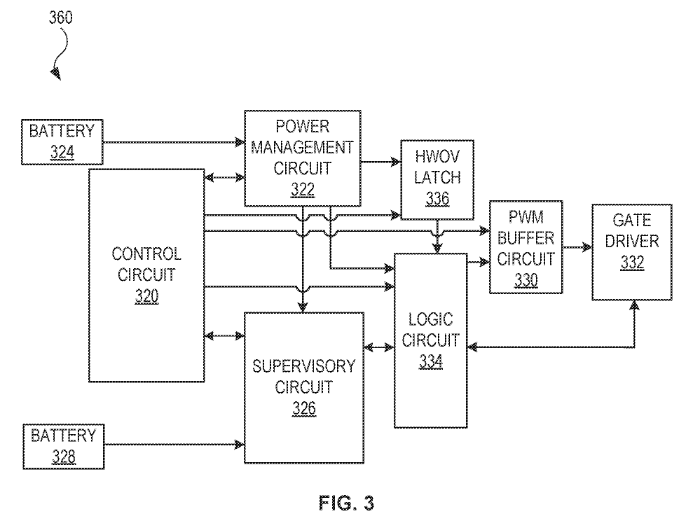

FIG. 3 illustrates a block diagram of a system 360 used to manage aspects of a vehicle, in accordance with aspects of the present disclosure. The system 360 may be used by vehicles (e.g., vehicle 100 and vehicle 200 shown in FIGS. 1 and 2, respectively) to manage high voltage applications, such as high voltage direct current (DC) to alternating current (AC) applications for powering drive units, including electric motors, of a vehicle. In this regard, the system 360 may include a control circuit 320 designed to manage the traction inverter functionality for a vehicle. The control circuit 320 may include one or more of a central processing unit, one or more microelectromechanical system (MEMS) controllers, or one or more microcontrollers. The control circuit 320 may function as a main control circuit for inverter functionality.

The system 360 may further include a power management circuit 322 designed to manage power supply to various circuits of the system 360. The power management circuit 322 may take the form of a PMIC. In this regard, a battery 324 may provide a low voltage (e.g., 12 Volt (V))) power supply to the power management circuit 322. Based on the power supply provided by the battery 324, the power management circuit 322 may distribute either a 5 V or a 12 V power supply to various circuits of the system 360, depending on the power requirements of the respective circuits. Although not shown, a backup battery may be present as an alternate power source to the battery 324. As shown, the control circuit 320 is in electrical communication with the power management circuit 322, allowing the power management circuit 322 to power the control circuit 320, as well as transmit communication to and receive communication from the control circuit 320.

The system 360 may further include a supervisory circuit 326. The supervisory circuit 326 may include any type of hardware circuit as described for the control circuit 320. The supervisory circuit 326 may function as a supervisory circuit (e.g., supervisory microcontroller) designed to monitor for faults in a vehicle. The supervisory circuit 326 is in communication with the control circuit 320 and the power management circuit 322, and may receive an indication of a fault from either or both of the control circuit 320 and the power management circuit 322. The indication may include a notification of a fault to the control circuit 320 and the power management circuit 322, a notification of a fault to another circuit of the system 360, and/or a notification of a loss of power to the control circuit 320, the power management circuit 322, and/or another circuit of the system 360. In addition to receive indications of faults, the supervisory circuit 326 may actively monitor for a fault to the control circuit 320, the power management circuit 322, and/or another circuit of the system 360.

In one or more implementations, when a fault is detected and/or communicated to the supervisory circuit 326, the supervisory circuit 326 assumes control and manages one or more functions, previously managed by the control circuit 320, and initiates, or executes, a fault action to operate a vehicle in a safe state. The supervisory circuit 326 may manage the power inverter applications for operating a motor(s) of the vehicle. Moreover, based on the received fault, the supervisory circuit 326 may take over control functions from at least one of the control circuit 320 or the power management circuit 322. This will be further discussed below. Also, a battery 328 may provide a low voltage (e.g., 12 Volt (V))) power supply to the power management circuit 322. Although not shown, a voltage regulator may be electrically connected to the battery 328 to control the voltage provided to the controller 326. In this regard, the voltage regulator may provide, based on the battery 328, 5 V or 12 V power.

The system 360 may further include a pulse width modulation buffer circuit 330 (PWM buffer circuit) used to provide signals (e.g., pulse signals), via a gate driver 332, used to drive a power module (not shown in FIG. 3). The control circuit 320 may control the pulse width modulation buffer circuit 330 via a logic circuit 334. The logic circuit 334 may utilize discrete logic to provide signals, based on commands from the control circuit 320, to the pulse width modulation buffer circuit 330 and/or the gate driver 332. Further, in the event of a fault detected by or communicated to the supervisory circuit 326, the supervisory circuit 326 assume control of the pulse width modulation buffer circuit 330 via the logic circuit 334 or the control circuit 320 may pass control of the pulse width modulation buffer circuit 330 to the supervisory circuit 326.

Additionally, the system 360 may include a hardware overvoltage latch 336 (HWOV latch) designed to monitor, for example, high voltage battery input to an inverter module (not shown in FIG. 3). If the high voltage is greater than a threshold voltage, the hardware overvoltage latch 336 may provide an overvoltage signal to the logic circuit 334, which may trigger a fault.

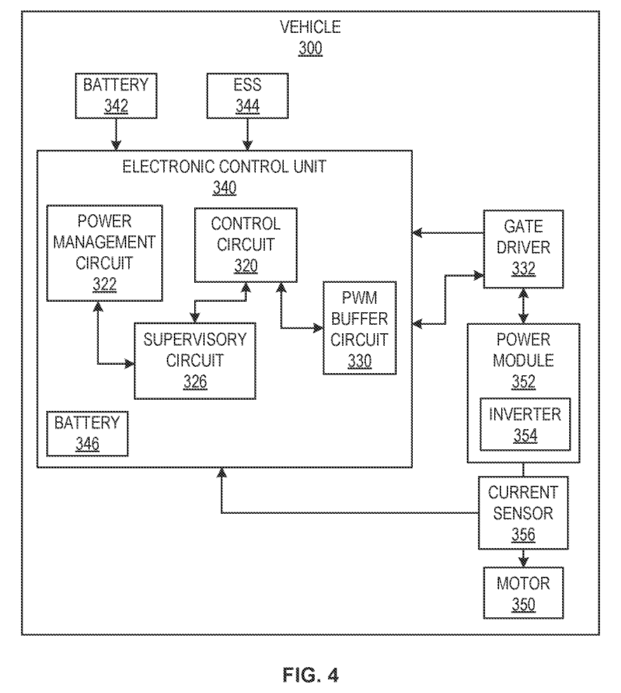

FIG. 4 illustrates a block diagram of a vehicle 300, in accordance with aspects of the present disclosure. The vehicle 300 may include an electronic control unit 340 (ECU) that includes several features of the system 360 (shown in FIG. 3). For example, the electronic control unit 340 may include the control circuit 320, the power management circuit 322, the supervisory circuit 326, the pulse width modulation buffer circuit 330, and the gate driver 332. As shown, the gate driver 332 is in communication with the electronic control unit 340, including the components of the electronic control unit 340. The gate driver 332 may include circuitry that amplifies a low-power signal from a controller (e.g., control circuit 320 or supervisory circuit 326) into a high-current signal for a transistor's gate. In addition to managing power supply (e.g., low voltage power) for the control circuit 320, the power management circuit 322 may also manage power to the gate driver 332.

The vehicle 300 may further include a battery 342 and an energy storage system 344 (ESS). The battery 342 may provide a low voltage (e.g., 5 V or 12 V) to the electronic control unit 340, including the aforementioned components of the electronic control unit 340. Additionally, the electronic control unit 340 may include a battery 346, which may provide a low voltage backup power supply in the event the battery 342 is unable to power the electronic control unit 340.

The energy storage system 344 may provide a high voltage (e.g., 500 V to 900 V) power supply for some components of the vehicle 300. The energy storage system 344 may include features similar to those of the battery pack 102 (shown in FIG. 1). In this regard, the energy storage system 344 may provide power to a motor 350 of the vehicle 300, via the electronic control unit 340 and a power module 352. The motor 350 may be representative of one or more electric motors, including one or more three-phase electric motors. The motor 350 may be part of a drive unit (e.g., drive unit 110 shown in FIG. 1) of the vehicle 300. The power module 352 may include an inverter 354, including a 3-phase inverter, used to control AC power to the motor 350. The vehicle 300 may further include a current sensor 356 that monitors the electrical current provided, via the power module 352, from the energy storage system 344 to the motor 350 for propulsion. The electronic control unit 340 may send, via one or more components of the electronic control unit 340, a control signal or control signals, containing instructions or commands, to the power module 352 and the inverter 354 via the gate driver 332.

During normal operation (e.g., when no fault(s) is/are detected), the control circuit 320 controls functions as a main control circuit for managing power from the energy storage system 344 to the motor 350. In this regard, the control circuit 320 may control the pulse width modulation buffer circuit 330 to provide outputs with specified duty cycles that allow the gate driver 332 to control the switching frequency for switches (e.g., switches of the inverter 354), thereby regulating AC to the motor 350. Also, the power management circuit 322 manages supplying power (e.g., low power) to the circuitry of the electronic control unit 340, and the supervisory circuit 326 functions as a supervisory circuit by monitoring and/or communicating with the control circuit 320 and the power management circuit 322 to determine whether a fault has occurred.

However, when a fault is detected (e.g., at the control circuit 320 or at the power management circuit 322), the supervisory circuit 326 may control the functions of the vehicle 300 to maintain safe state control of the vehicle 300. For example, the supervisory circuit 326 may read the state (e.g., via serial communication) of the control circuit 320 and/or the power management circuit 322 to determine whether a fault occurred. This may include determining whether a fault has occurred to the control circuit 320 and/or the power management circuit 322. Additionally, the supervisory circuit 326 may determine a fault to the control circuit 320 and/or the power management circuit 322 based on a lack of communication between the supervisory circuit 326 and the control circuit 320 and/or between the supervisory circuit 326 and the power management circuit 322. In one or more implementations, in the event of a fault, the control circuit 320 passes control of at least some functions previously assigned to the control circuit 320, including control of the pulse width modulation buffer circuit 330, to the supervisory circuit 326.

Based on the state determined by the supervisory circuit 326 from reading the control circuit 320 and/or the power management circuit 322, the supervisory circuit 326 may initiate safe state control by, for example, controlling the motor 350 via regulating the pulse width modulation buffer circuit 330 to control the motor 350. In this regard, the supervisory circuit 326 may control the motor 350, in the event of a fault to the control circuit 320, to manage the vehicle 300 against unintended acceleration, unintended deceleration, or yaw torque that could cause a safety hazard. Also, the control circuit 320 may provide a flag (e.g., fault flag) to the supervisory circuit 326 to provide an indication to the supervisory circuit 326 which circuit(s) has/have undergone a fault.

In one or more implementations, when a fault to the control circuit 320 is determined, the supervisory circuit 326 disables the pulse width modulation buffer circuit 330 via a logic circuit (e.g., logic circuit 334 shown in FIG. 3), thus further controlling the motor 350. The supervisory circuit 326 may determine the fault by, for example, communication from the power management circuit 322 indicating a fault or determining a loss of power to the control circuit 320. Additionally, the supervisory circuit 326 may determine a fault based on, for example, a loss of power to the power management circuit 322 or improper functioning of the power management circuit 322.

The supervisory circuit 326 may determine a fault through other means. For example, the supervisory circuit 326 may determine a fault based on the speed of the vehicle 300. This may include, for example, receiving an input (e.g., indicating phase current and frequency of the phase current) from the current sensor 356 indicating the electrical current to the motor 350. Based on the speed of the vehicle 300 being a function of the output of the motor 350, which in turn is a function of received electrical current, the supervisory circuit 326 may monitor and determine an estimated speed of the vehicle 300 based on the electrical current sensed by the current sensor 356. The supervisory circuit 326 may further obtain the actual speed of the vehicle 300. When the estimated speed of the vehicle 300 does not match (e.g., to within a threshold speed) the actual speed of the vehicle 300, the supervisory circuit 326 may determine a fault and subsequently initiate a corresponding fault action. In this regard, the electrical current, including the phase current, and the speed of the vehicle 300 may be determined by the supervisory circuit 326 prior to determining the fault action to be taken.

Additionally, the supervisory circuit 326 may monitor the voltage provided by the energy storage system 344 to determine whether the energy storage system 344 is providing a desired amount of electrical current. Further, the supervisory circuit 326 may receive fault inputs from, for example, the control circuit 320 via the gate driver 332 related to desaturation bias voltage (e.g., to the inverter 354) or a bias undervoltage (e.g., to the gate driver 332). When the fault is determined, the supervisory circuit 326 may initiate a fault action, such as providing a short circuit high (e.g., three-phase electrical short to a high voltage bus electrically coupled with the energy storage system 344) to the motor windings of the motor 350, a short circuit low (e.g., three-phase electrical short to an electrical ground) to the motor windings of the motor 350, or opening one or more circuits or gates (e.g., of the gate driver 332), thus placing the operation of the vehicle 300 in a safe state.

Also, in the event of a hardware overvoltage fault, a latch (e.g., hardware overvoltage latch 336 shown in FIG. 3) may be opened by the control circuit 320. In one or more implementations, the control circuit 320 may provide a command to open the latch provided there is no indication of a desaturation bias voltage fault or an bias undervoltage fault. The control circuit 320 may reset the latch using the pulse width modulation circuit buffer circuit 330.

Alternatively, in one or more implementations, when a fault is determined at the supervisory circuit 326, the control circuit 320 retains safe state control. In this regard, the control circuit 320 may control (e.g., directly control) the pulse width modulation buffer circuit 330 by controlling corresponding duty cycles for a short circuit high, short circuit low, or an open (e.g., opening one or more circuits or gates (e.g., of the gate driver 332)) to operate the vehicle 300 in a safe state. In this regard, the control circuit 320, while operating in safe state based on a fault detected at the supervisory circuit 326, may limit speed and safety performance until the vehicle 300 is stopped.

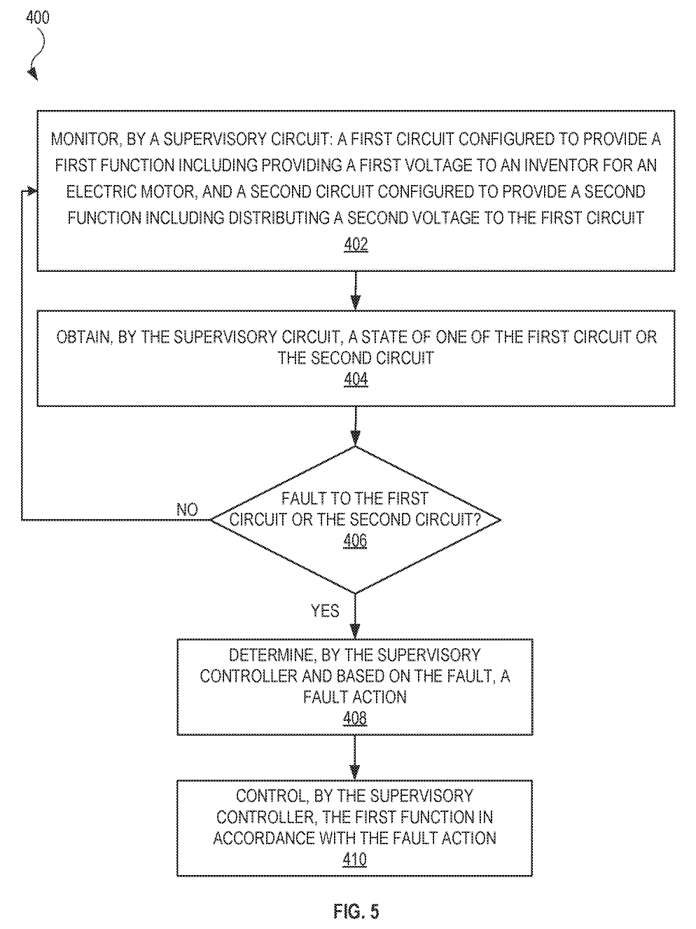

Also, in one or more implementations, the energy storage system 344 may be used as a backup power supply in the event of a fault to the battery 342. In this regard, the vehicle 300 may include a DC to DC converter (not shown in FIG. 5) that converts the high voltage from the energy storage system 344 to a lower voltage (e.g., 5 V to 12 V).

FIG. 5 illustrates a flow diagram showing an example of a process 400 that may be performed for managing one or more operations of a vehicle, in accordance with implementations of the subject technology. For explanatory purposes, the process 400 is primarily described herein with reference to the system 360 or the vehicle 300 shown in FIGS. 3 and 4. However, the process 400 is not limited to the system 360 or vehicle 300 shown in FIGS. 3 and 4, and one or more blocks (or operations) of the process 400 may be performed by one or more other components of other suitable moveable apparatuses, devices, or systems. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, a supervisory circuit monitors i) a first circuit configured to provide a first function including providing a first voltage to an inverter for an electric motor, and ii) a second circuit configured to provide a second function including distributing a second voltage to the first circuit. The second voltage is less than the first voltage. The first circuit may take the form of a main control circuit for operating an inverter application during normal operation. The second circuit may provide to various circuits for operation of the respective circuits.

At block 404, the supervisory circuit obtains a state of one of the first circuit or the second circuit. The state of the first circuit or the second circuit may provide the supervisory circuit with an indication as to whether the first circuit and/or the second circuit are operating normally, or alternatively, operating with a fault.

At block 406, a determination is made whether a fault has occurred to the first circuit or the second circuit. The supervisory circuit may determine whether a fault has occurred, based on, for example, communicating with the first and second circuits, receiving a fault flag from the first and/or second circuits, or determining a loss of power to the first and/or second circuits. When no fault is determined, the process 400 returns to block 402. When a fault is determined, the process 400 proceeds to block 408.

At block 408, a fault action is determined by the supervisory circuit, with the fault action being based on the fault. The fault action may place a vehicle in a safe state operation by, for example, limiting the electric motor.

At block 410, the supervisory circuit controls the first function in accordance with the fault action. This may include, for example, the supervisory circuit controlling a PWM buffer circuit (e.g., pulse width modulation buffer circuit 330 shown in FIG. 4), including disabling the PWM buffer circuit. The first circuit may pass the first function, previously controlled by the first circuit, to the supervisory circuit.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being "connected" or "coupled" to another element, it is to be understood that the elements can be directly connected to the other element, or have intervening elements present between the elements. In contrast, when an element is referred to as being "directly connected" or "directly coupled" to another element, it should be understood that no intervening elements are present in the "direct" connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a first circuit configured to control one or more functions of an inverter for an electric motor that is configured to operate based on a first voltage;
a second circuit configured to distribute power, based on a second voltage less than the first voltage, to the first circuit; and
a third circuit configured to:
determine, based on communication with at least one of the first circuit or the second circuit, a state of the first circuit, and
in response to the state indicating a fault to the first circuit, determine a fault action to manage the electric motor.

2. The apparatus of claim 1, wherein the fault action comprises providing a command to control the inverter.

3. The apparatus of claim 1, wherein the state comprises a loss of the second voltage to the first circuit.

4. The apparatus of claim 1, wherein:
the one or more functions comprises managing a pulse width modulation (PWM) buffer circuit to a power module, and
in response to the state indicating the fault, the third circuit is configured to disable the PWM buffer circuit.

5. The apparatus of claim 4, wherein the third circuit is further configured to:
monitor, based on a current sensor, phase current to the electric motor, and
prior to determining the fault action, determine, based on the phase current to the electric motor, a speed of a vehicle based on the electric motor.

6. The apparatus of claim 5, wherein the third circuit is further configured to determine, based on the speed, the fault action.

7. The apparatus of claim 1, wherein:
the one or more functions comprises managing a pulse width modulation (PWM) buffer circuit to a power module, and
in response to the state indicating the fault, the first circuit is configured to pass control of the PWM buffer circuit to the third circuit.

8. The apparatus of claim 7, wherein the first circuit is configured to provide duty cycles of the PWM buffer circuit to a gate driver.

9. The apparatus of claim 1, wherein the fault action is selected from one of a short circuit high, a short circuit low, or an open.

10. A method, comprising:
monitoring, by a supervisory circuit:
a first circuit configured to provide a first function including providing a first voltage to an inverter for an electric motor, and
a second circuit configured to provide a second function including distributing a second voltage to the first circuit, the second voltage less than the first voltage;
obtaining, by the supervisory circuit, a state of one of the first circuit or the second circuit; and
in response to determining, based on the state, a fault to the first circuit or the second circuit:
determining, by the supervisory circuit and based on the fault, a fault action, and
controlling, by the supervisory circuit, the first function in accordance with the fault action.

11. The method of claim 10, wherein monitoring, by the supervisory circuit, the first circuit comprises communicating with the second circuit.

12. The method of claim 10, wherein the fault action comprises providing a command to control the inverter.

13. The method of claim 10, wherein the fault comprises a loss of the second voltage to the first circuit.

14. The method of claim 10, wherein:
the first function comprises managing a pulse width modulation (PWM) buffer circuit to a power module, and
in response to the state indicating the fault, disabling, by the supervisory circuit, the PWM buffer circuit.

15. The method of claim 14, wherein the supervisory circuit is further configured to:
monitor, based on a current sensor, phase current to the electric motor; and
prior to determining the fault action, determine, based on the phase current to the electric motor, a speed of a vehicle based on the electric motor.

16. The method of claim 15, further comprising determining, by the supervisory circuit and based on the speed, the fault action.

17. A vehicle, comprising:
an electric motor;
an energy storage system configured to provide a first voltage;
a battery separate from the energy storage system and configured to provide a second voltage less than the first voltage;
an inverter comprising one or more switches configured to operate the electric motor; and
an electronic control unit configured to provide one or more control signals to the inverter, the electronic control unit comprising:
a first circuit configured to control one or more functions of an inverter for an electric motor configured to operate based on the first voltage;
a second circuit configured to distribute power, based on the second voltage, to the first circuit; and
a third circuit configured to:
determine, based on communication with at least one of the first circuit or the second circuit, a state of the first circuit, and
in response to the state indicating a fault to the first circuit, determine a fault action to manage the electric motor.

18. The vehicle of claim 17, wherein the fault action comprises providing a command to control the inverter.

19. The vehicle of claim 17, wherein the state comprises a loss of the second voltage to the first circuit.

20. The vehicle of claim 19, wherein:
the one or more functions comprises managing a pulse width modulation (PWM) buffer circuit to a power module, and
in response to the state indicating the fault, the third circuit is configured to disable the PWM buffer circuit.
